(19) United States
(12) Patent Application Publication
(10) Pub. No.: US 2015/0121517 A1
(43) Pub. Date: Apr. 30, 2015

(54) BUNDLE-TO-BUNDLE AUTHENTICATION IN MODULAR SYSTEMS

(71) Applicants: STEFAN DIMOV, Palo Alto, CA (US); MOHAMMAD ASIF KHAN, Santa Clara, CA (US)

(72) Inventors: STEFAN DIMOV, Palo Alto, CA (US); MOHAMMAD ASIF KHAN, Santa Clara, CA (US)

(21) Appl. No.: 14/063,033

(22) Filed: Oct. 25, 2013

(51) Int. Cl. G06F 21/62; G06F 21/34

(52) U.S. Cl. CPC G06F 21/6218; G06F 21/34
USPC 726/20

(57) ABSTRACT

A bundle-to-bundle authentication process is presented that provides a flexible authentication mechanism to application bundles for accessing the persistence bundle of a modular application and requesting security sensitive data from a database. The modular application comprises a plurality of bundles such as application bundles, connector bundles, persistence bundles, authentication bundles, and so on. During runtime of the modular application, the application bundles and the connector bundles may need access to security protected resources (sensitive data) stored in the database. To access these resources, the application bundles and the connector bundles should authenticate themselves with the persistence bundle. The persistence bundle provides the communication with the database.

### BACKGROUND

Modular systems support modular programming Modular programming separates the functionality of a program into interchangeable modules, such that a module contains everything necessary to execute only one aspect of the desired functionality. A module (which can contain a number of separate processes) works independently from another module. Such modules may be, for example, bundles. A bundle is a software module that includes a set of resources, such as classes, descriptor files, manifest files, services, and so on. An application may contain a plurality of bundles that perform different functionalities of the application. Applications or software components that are developed in bundles can be remotely installed, started, stopped, updated, etc. These applications typically run on modular frameworks such as the OSGi™ (Open Source Gateway initiative) framework. The OSGi™ framework and environment is a modular system and a service platform for the Java™ programming language that implements a dynamic component model. Application lifecycle management (start, stop, install, etc. operations) is performed via application programming interfaces (APIs) that allow remote downloading of management policies. A service registry, as part of the framework, allows bundles to detect addition of new services or the removal of services and adapt accordingly.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an architectural view of a computing system including a modular framework, according to some embodiments.

FIG. 2 is a block diagram illustrating an architectural view of a modular application, according to some embodiments.

FIG. 3 is a block diagram illustrating a modular application including an authentication bundle, according to some embodiments.

FIG. 4 is a sequence diagram illustrating bundle-to-bundle authentication in a modular application, according to some embodiments.

FIG. 5 is a flow diagram illustrating bundle-to-bundle authentication in a modular application, according to some embodiments.

FIG. 6 is a block diagram of an exemplary computer system 600, according to some embodiments.

### DETAILED DESCRIPTION

Embodiments of techniques for methods and systems including bundle-to-bundle authentication in modular systems are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Some of the application bundles may be security sensitive. For example, a persistency bundle may expose an API that provides access to sensitive data in a database. Some application bundles may be designated to use that API, but other bundles should not have access to the sensitive data. Therefore, a bundle-to-bundle authentication mechanism should be in place to manage the security side of the bundles communication.

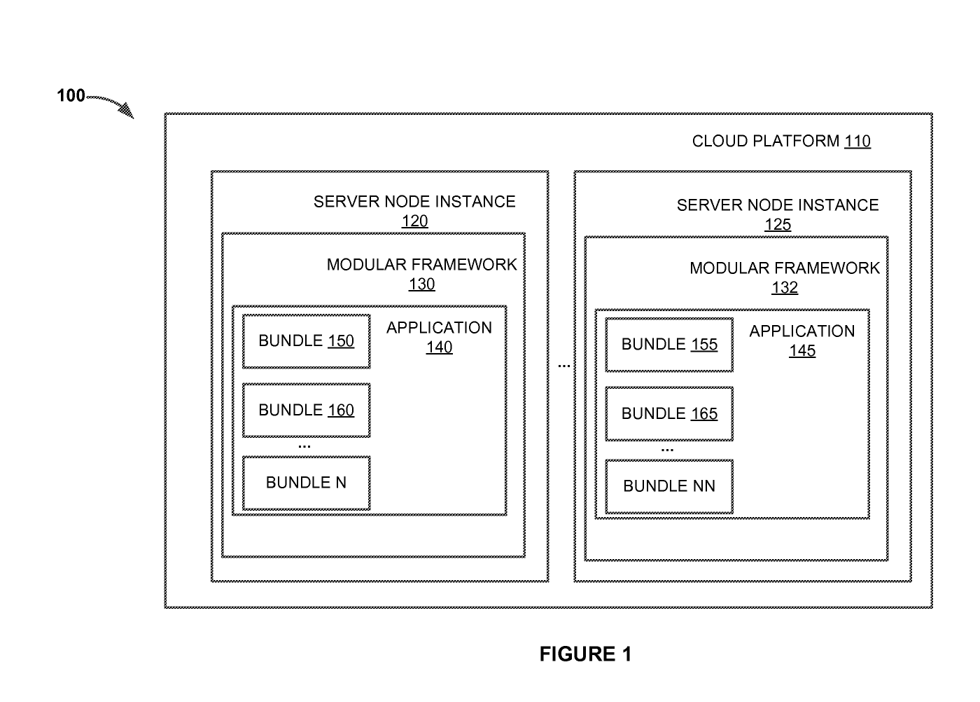

FIG. 1 is a block diagram illustrating an architectural view of a computing system including a modular framework, according to some embodiments. System 100 may comprise a general-purpose computing system and may execute program code to perform one or more of the processes described herein. Computing system 100 includes cloud platform 110 that enables a large number of computers to be connected through a real-time network such as the Internet. In this way, hosted application services that run on the cloud platform 110 can be provisioned to run client server software on a remote location. End users may access the cloud-based applications through a Web browser, a thin client, or a mobile application, while the business software and the users data are stored on server nodes at a remote location. Cloud providers install and operate application software in the cloud and cloud users access the software from cloud clients. Cloud users may not manage the cloud infrastructure and platform where the application runs. This would eliminate the need to install and run the application on the cloud user's own computers, which simplifies maintenance and support.

In various embodiments, cloud platform 110 includes a number of server node instances such as server node instance 120 and server node instance 125. A server node instance represents a virtual server node that may include at least an operating system, a programming language execution environment, a database, and a Web server. Application developers can develop and run their software solutions on the cloud platform server node instances without the cost and complexity of buying and managing the underlying hardware and software layers.

Server node instances may include an application server (such as Apache Tomcat™) that runs on the server node instance. The application server represents a framework that provides a generalized approach for creating an application-server implementation. For example, in case of Java application servers, the application server behaves like an extended virtual machine for running applications. In some embodiments, the application server includes a modular framework such as modular framework 130 and modular framework 132. The modular frameworks support and run a number of applications such as application 140 and application 145. In various embodiments, the modular frameworks represent modular environments that support deployment and management of modular applications. For example, OSGi™ environment is a modular system and a service platform for the Java™ programming language.

Application 140 includes a plurality of bundles (e.g., bundle 150, bundle 155, bundle 160, bundle 165, and bundle N) that perform different functionalities of the application. Applications or software components that are developed in bundles can be remotely installed, started, stopped, updated, etc. While an application is running, some of the bundles may be stopped to prevent a given functionality to be executed in the application. If there are some dependent bundles from the stopped bundles, then the dependent bundles may be notified by the modular environment (e.g., the OSGi™ environment) and may also be stopped or may continue to work, but with limited functionality (e.g., without the functions provided by the stopped bundles). Later, the stopped bundles can be started again. The modular environment may again notify the dependent bundles that the stopped bundles have been started and use their functionality in the application. In this way, the application becomes more flexible to the users.

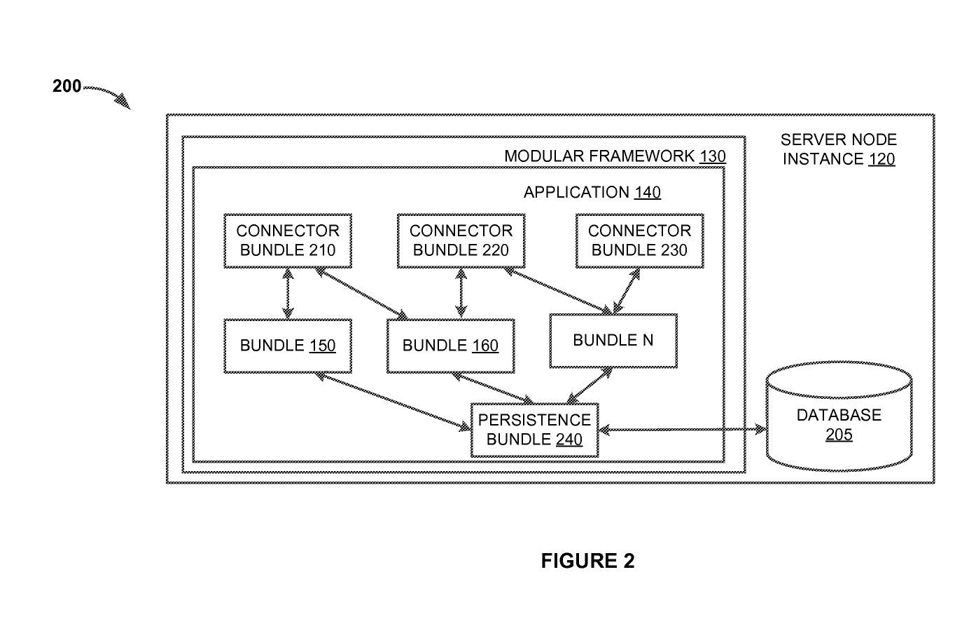

FIG. 2 is a block diagram illustrating an architectural view of a modular application, according to some embodiments. Service node instance 120 is represented to include modular framework 130 and database 205. System 200 may include other unshown elements according to some embodiments. Modular framework 130 includes one or more modular applications such as application 140. Application 140 includes a plurality of software modules structured as bundles. Depending on the function of the bundles, there may be different type of bundles such as: 1) standard application bundles (e.g., bundle 150, bundle 160, bundle N); 2) connector bundles (e.g., connector bundle 210, connector bundle 220, and connector bundle 230); 3) persistence bundles 240; etc.

Standard application bundles represent application modules that separate the functionality of an application into independent, interchangeable bundles, such that a bundle may contain everything necessary to execute only one aspect of the desired functionality of the application. Each bundle (which can contain a number of separate processes) may work independently from another bundle.

Persistence bundle 240 communicates with database 205. In various embodiments, from the plurality of bundles in the modular application 140, only the persistence bundles are designated to communicate with the database 205. The communication includes operations such as sending requests and receiving data. When a bundle needs to get data from the database, that bundle sends a request to the persistence bundle 240. Then, the persistence bundle 240 sends the request to the database. The returned data is passed through the persistence bundle 240 to the requesting bundle.

Connector bundles represent software modules that can be used to connect third-party providers' bundles to the standard application bundles of the modular application 140. The connector bundles use the standard application bundles and the persistence bundle 240 to work with the modular application 140 and the modular framework 130. For example, modular application 140 is an application for providing and managing resources for electric cars. The resources may include parking lots, charging stations, and so on. Some of the resources may be provided by different vendors that may be partners with the provider of the modular application 140. Their resources may be located at the partners' systems in form of a functionality implemented with data, application modules, etc. For every partner's functionality, there are one or more connector bundles. The connector bundles connect to the partners' server systems, extract the needed information, and send it to the database 205. At the database 205, the extracted information (e.g., data) is aggregated. Later, when a user requests that data, the modular application connects to the partner's server system via the connector bundles to invoke the corresponding application module with the needed functionality. The partner's server system sends a request to the corresponding connector bundle of the modular application 140, which in turn sends the request to the database 205. However, this request is first sent to the persistence bundle 240 to check permissions for accessing the data in the database. When, the request is authorized, it is sent to the database.

In various embodiments, a connector bundle may have more than one responsibility. The connector bundle may be used to periodically connect to a partner's server system to extract application data and send it to the database, where the data is aggregated. The connector bundle may also be used by the partner's server system to connect to the database to request the aggregated data.

In some embodiments, the modular application 140 may be provided to third parties as a software development kit (SDK) as well. This means that at least a portion of the software libraries (e.g., the application programming interfaces) may be exposed so that the third parties may be able to develop their own connector bundles and deploy them on the modular framework 130 as part of the modular application 140.

Some of the data in the database 205 may be security sensitive and available to specific bundles (standard application bundles and connector bundles). For example, the data extracted from one provider's system may be accessible from the provider's corresponding connector bundle only and not from other partners' connector bundles. Security sensitive data may also be used by standard application modules inside the modular application 140. For example, in an HR application regarding employees of a company, some application bundles may have access to data such as employees' salaries, but other application bundles may not have permission to access that data. Thus, in various embodiments, the persistence bundles check if a given bundle has authorization to request and access some data from the database. The persistence bundles are mediators between the modular application bundles (including the connector bundles) and the database. The persistence bundles perform the communication with the database 205.

In some embodiments, the modular framework 130 may be an OSGi™ modular framework. The OSGi™ framework supports various settings to be made to the files and descriptors for the modular applications' bundles. For example, a bundle of the modular application 140 may include a descriptor file (e.g., an XML file) that comprises a plurality of settings for that bundle. The OSGi™ framework provides functions to configure some of the settings of the descriptor file to include the names or the identifiers of the bundles (application bundles and connector bundles) that have permission to access the persistence bundle. In this way, the bundles that are not listed do not to have access permission to the persistence bundle and to the sensitive data in the database correspondingly. However, in a scenario that the modular application 140 has to be ported to a different modular framework (than the OSGi™ framework), the configured settings (to restrict some of the bundles from access) in the descriptor file of the persistence bundle may not be applicable in the new framework or may require additional implementation and support.

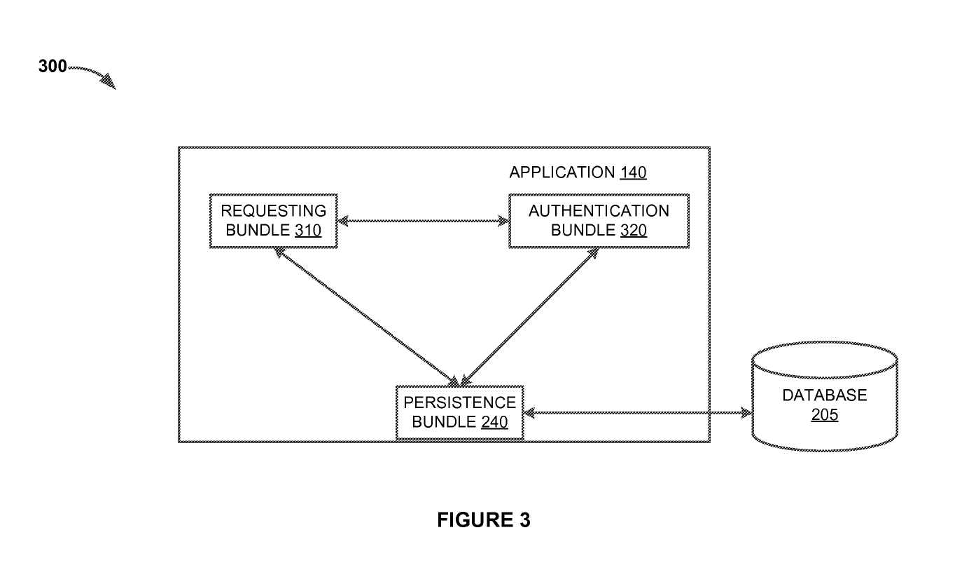

FIG. 3 is a block diagram illustrating a modular application including an authentication bundle, according to some embodiments. In various embodiments, an authentication bundle is included in a modular application to authenticate requesting bundles (standard application bundles and connector bundles) with the persistence bundles. After the authentication is confirmed, the requesting bundles are granted with access to the persistence bundle. Using the persistence bundle 240, the requesting bundles can communicate with the database 205 and retrieve security sensitive resources.

Requesting bundle 310 may be a standard application bundle (such as bundle 150, bundle 160, and bundle N) or a connector bundle (such as connector bundle 210, connector bundle 220, and connector bundle 230). The requesting bundle 310 is the bundle that requests access to security protected resources. Authentication bundle 320 generates a security token for the requesting bundle 310 for authentication with the persistence bundle 240. Persistence bundle 240 is the bundle that carries out the communication between the requesting bundle 310 and the database 205.

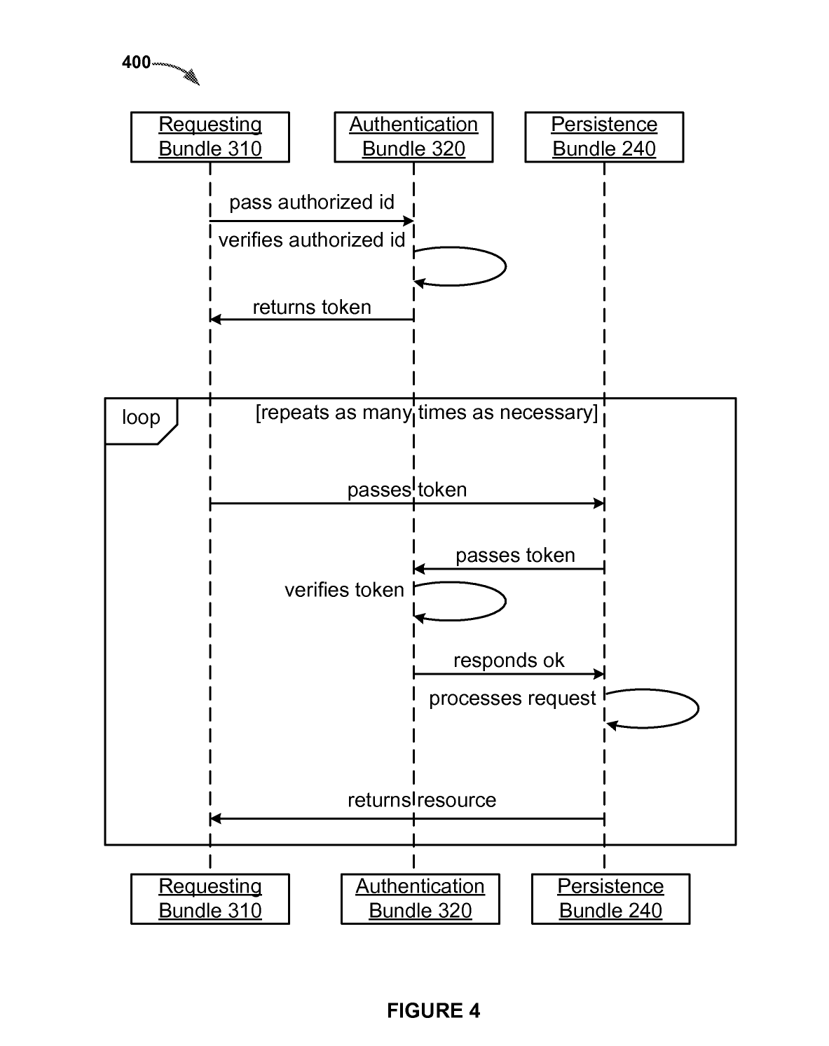

FIG. 4 is a sequence diagram illustrating bundle-to-bundle authentication in a modular application, according to some embodiments. In various embodiments, a bundle-to-bundle authentication process is presented that provides a flexible authentication mechanism to application bundles for accessing the persistence bundle of a modular application and requesting security sensitive data from the database. Sequence diagram 400 includes steps performed among: requesting bundle 310, authentication bundle 320, and persistence bundle 240.

In various embodiments, the requesting bundle 310 includes a predefined authorized identifier (ID). The authorized ID may be hardcoded in the requesting bundle class files, specified in the settings of the descriptor file of the requesting bundle 310, and so on. The authorized ID may be used as an identifier of the requesting bundle 310. In some embodiments, the authorized ID may be unique. The authorized ID represents a String of signs that may be used for authentication.

The requesting bundle 310 sends a request to the authentication bundle 320 for accessing persistence bundle 240. The request includes the authorized ID. The request bundle 310 passes the authorized ID to the authentication bundle 320 for authentication. Next, the authentication bundle 320 verifies the received authorized ID from the requesting bundle 310. If the authorized ID is valid, then the requesting bundle 310 is permitted to access the persistence bundle 240. In that case, the authentication bundle 320 generates a dynamic security token for the requesting bundle 310. The dynamic security token represents a temporary access code of type “String” (e.g., numbers) that is valid for a certain period of time for the bundle for which it was generated.

In various embodiments, the generation of the dynamic security token is performed at runtime. Further to the generation of the security token, the authentication bundle 320 computes a hash code of the generated security token. The hash code of the generated security token is stored in the authentication bundle 320. Next, the authentication bundle 320 returns the generated security token to the requesting bundle 310. The next steps of the bundle-to-bundle authentication may be performed in a loop, this is, to be repeated as many times as necessary with the generated security token in a user session.

Once the generated security token is received, the requesting bundle 310 may send request to access to the persistence bundle 240. The request includes the generated security token. Next, persistence bundle 240 passes the generated security token to the authentication bundle 320 for verification. Then, the authentication bundle 320 calculates a hash code of the received security token and compares the newly calculated hash code with the stored hash code for the security token. If the two hash codes are identical, then the authentication bundle 320 confirms the identity of the requesting bundle 310 based on the generated security token. Then, access to the persistence bundle 240 is granted. In some embodiments, the persistence bundle 240 returns an instance of one or more classes. Using this instance and a given API, the requesting bundle may request security sensitive resources in database 205 via the persistence bundle 240. Different classes and instances may give different levels of access to the database. In other embodiments, after the access is granted to the persistence bundle 240, the requesting bundle 310 may directly request the data in the database 205. The persistence bundle 240 returns the requested resources.

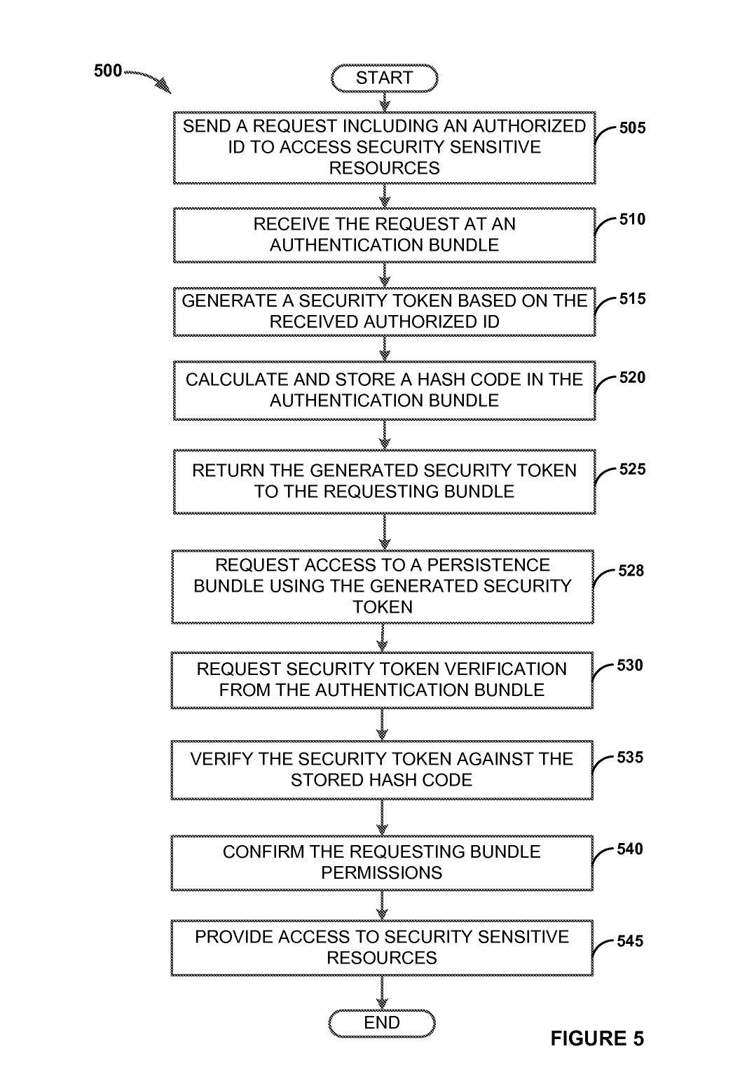

FIG. 5 is a flow diagram illustrating bundle-to-bundle authentication in a modular application, according to some embodiments. In some embodiments, various hardware elements (e.g., processors) execute program code to perform process 500. Process 500 and other processes described herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 500 comprises steps for bundle-to-bundle authentication in a modular application running in a cloud environment. The bundle-to-bundle authentication may be applicable in various scenarios that include a group of modules needing an authentication mechanism. In various embodiments, the modular application comprises a plurality of bundles such as application bundles (e.g., bundle 150, bundle 160, and bundle N), connector bundles (e.g., connector bundle 210, connector bundle 220, and connector bundle 230), persistence bundles (e.g., persistence bundle 240), authentication bundles (e.g., authentication bundle 320), and so on. During runtime of the modular application 140, the application bundles and the connector bundles may need access to security protected resources (sensitive data) stored in database 205. To access these resources, the application bundles and the connector bundles should authenticate themselves with the persistence bundle 240. Persistence bundle 240 is the bundle that provides the communication with the database 205. The application bundles and the connector bundles may also be represented as requesting bundles (e.g., requesting bundle 310), since these are the bundles that request access to the security sensitive resources.

At block 505, a request is sent from a requesting bundle to an authentication bundle in a modular application to request access to security sensitive resources. The request includes a predefined authorized identifier (ID) that is specified in the requesting bundle source code files (e.g., hardcoded in class files, specified in descriptor files, and so on). At block 510, the request including the authorized ID is received at the authentication bundle. The authentication bundle generates a security token based on the received authorized ID, at block 515.

At block 520, a hash code for the generated security token is calculated and stored in the authentication bundle. At block 525, the generated security token is returned to the requesting bundle. The security token is needed by the requesting bundle to authenticate with the persistence bundle of the modular application. At block 528, access to the persistence bundle is requested by the requesting bundle using the generated security token. The security token is included in the request sent from the requesting bundle to the persistence bundle.

At block 530, security token verification is requested by the persistence bundle from the authentication bundle. The persistence bundle sends a request including the received security token to the authentication bundle. At block 535, the security token is verified against the stored hash code in the authentication bundle. When the authentication bundle receives the request with the security token from the persistence bundle, the authentication bundle calculates a new hash code for the security token. Then, the authentication bundle compares the newly calculated hash code with the stored hash code. If the hash codes are identical, the permissions of the requesting bundle to the persistence bundle are confirmed, at block 540. The authentication bundle sends confirmation of the identity to the persistence bundle. Next, access is provided to the security sensitive resources for the requesting bundle from the persistence bundle, at block 545.

Once the access to the persistence bundle is granted and the requesting bundle can access the security sensitive resources in the database, the access itself may be executed depending on the type of implementation. In some embodiments, the persistence bundle 240 returns an instance of one or more classes. Using this instance and a given API, the requesting bundle may request security sensitive resources in database 205 via the persistence bundle 240. Different classes and instances may give different levels of access to the database. In other embodiments, after the access is granted to the persistence bundle 240, the requesting bundle 310 may directly request the data in the database 205. The persistence bundle 240 returns the requested resources.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

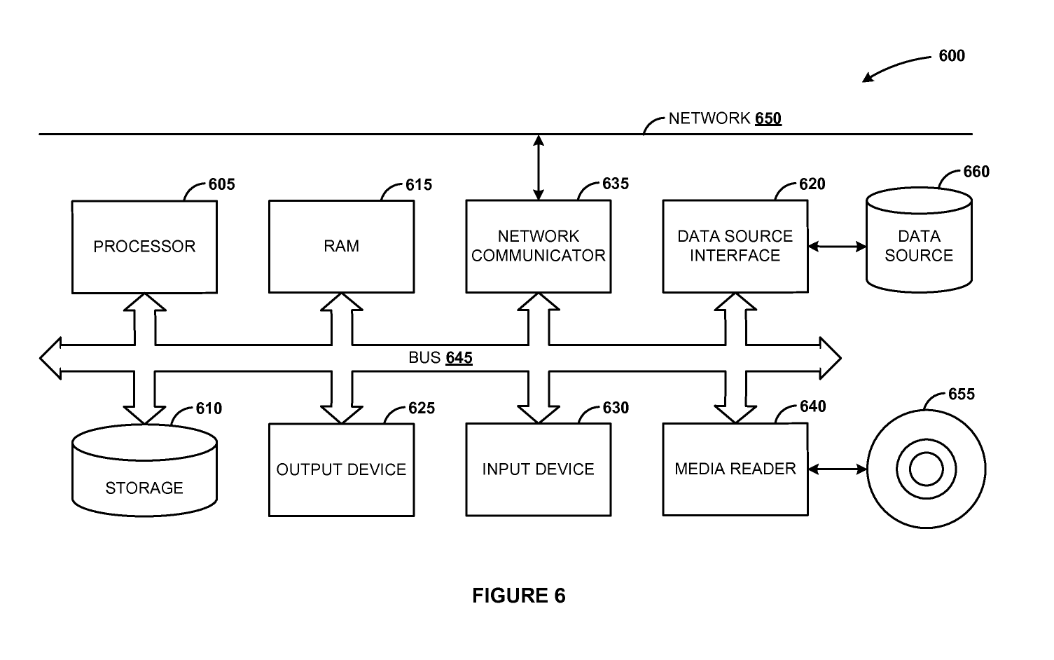

FIG. 6 is a block diagram of an exemplary computer system 600, according to some embodiments. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for bundle-to-bundle authentication in modular systems, the method comprising:
sending a request from a requesting bundle of a modular application running on a cloud platform to an authentication bundle in the modular application to request access to security sensitive resources stored in a database, wherein the request includes an authorized identifier;
generating a security token based on the received authorized identifier in the authentication bundle;
requesting access to a persistence bundle of the modular application using the generated security token, wherein the persistence bundle carries out communication between the requesting bundle and the database; and
verifying the security token with the authentication bundle to confirm permissions of the requesting bundle to the persistence bundle.

2. The method of claim 1, wherein generating the security token comprises:
calculating a hash code for the security token; and
storing the hash code in the authentication bundle.

3. The method of claim 2, wherein verifying the security token comprises:
calculating a new hash code for the security token in the authentication bundle;
comparing the newly calculated hash code with the stored hash code; and
upon determining that the newly calculated hash code is identical with the stored hash code, sending a confirmation to the persistence bundle.

4. The method of claim 1, further comprising:
confirming the permissions of the requesting bundle to the persistence bundle;
providing access to the persistence bundle; and
providing the requested security sensitive resources from the database to the requesting bundle via the persistence bundle.

5. The method of claim 1, wherein the requesting bundle is a standard application bundle or a connector bundle.

6. The method of claim 1, wherein the authorized identifier is predefined in a source file of the requesting bundle.

7. A computer system providing bundle-to-bundle authentication in modular systems, comprising:
a processor;
a memory in communication with the processor, the memory storing instructions related to:
a modular application running on a cloud platform;
a requesting bundle in the modular application to request access to security sensitive resources stored in a database, wherein the request includes an authorized identifier;
an authentication bundle in the modular application to generate a security token based on the received authorized identifier from the requesting bundle; and
a persistence bundle to receive the generated security token and upon verification of the security token to provide access to the database.

8. The computer system of claim 7, wherein the persistence bundle carries out communication between the requesting bundle and the database.

9. The system of claim 7, wherein the authentication bundle calculates and stores a hash code for the security token.

10. The system of claim 9, wherein the authentication bundle further calculates a new hash code for the security token, compares the newly calculated hash code with the stored hash code.

11. The system of claim 10, wherein the authentication bundle sends a confirmation to the persistence bundle upon determining that the newly calculated hash code is identical with the stored hash code.

12. The system of claim 7, wherein the persistence bundle provides access for the requesting bundle to the persistence bundle.

13. The system of claim 7, wherein the persistence bundle provides the requested security sensitive resources from the database to the requesting bundle.

14. A non-transitory computer-readable medium storing instructions, which when executed cause a computer system to:
send a request from a requesting bundle of a modular application running on a cloud platform to an authentication bundle in the modular application to request access to security sensitive resources stored in a database, wherein the request includes an authorized identifier;
generate a security token based on the received authorized identifier in the authentication bundle;
request access to a persistence bundle of the modular application using the generated security token, wherein the persistence bundle carries out communication between the requesting bundle and the database; and
verify the security token with the authentication bundle to confirm permissions of the requesting bundle to the persistence bundle.

15. The computer-readable medium of claim 14, wherein the instruction that causes the computer system to generate the security token further comprises instructions that cause the computer system to:
calculate a hash code for the security token; and
store the hash code in the authentication bundle.

16. The computer-readable medium of claim 15, wherein the instruction that causes the computer system to verify the security token further comprises instructions that cause the computer system to:
calculate a new hash code for the security token in the authentication bundle;
compare the newly calculated hash code with the stored hash code; and
upon determining that the newly calculated hash code is identical with the stored hash code, send a confirmation to the persistence bundle.

17. The computer-readable medium of claim 14 further comprising instructions that cause the computer system to confirm the permissions of the requesting bundle to the persistence bundle.

18. The computer-readable medium of claim 14, further comprising instructions that cause the computer system to:
provide access to the persistence bundle; and
provide the requested security sensitive resources from the database to the requesting bundle via the persistence bundle.

19. The computer-readable medium of claim 14, wherein the requesting bundle is a standard application bundle or a connector bundle.

20. The computer-readable medium of claim 14, wherein the authorized identifier is predefined in a source file of the requesting bundle.
